(19) United States
(12) Patent Application Publication
(10) Pub. No.: US 2017/0271712 A1
(43) Pub. Date: Sep. 21, 2017

(54) POSITIVE ELECTRODE ACTIVE MATERIAL FOR A LITHIUM ION SECONDARY BATTERY, METHOD FOR MANUFACTURING THE SAME, AND LITHIUM ION SECONDARY BATTERY

(71) Applicant: NEC Corporation, Tokyo (JP)

(72) Inventors: Katsumi MAEDA, Tokyo (JP); Sadanori HATTORI, Tokyo (JP); Noriyuki TAMURA, Tokyo (JP)

(73) Assignee: NEC Corporation, Tokyo (JP)

(21) Appl. No.: 15/517,260

(22) PCT Filed: Sep. 17, 2015
(86) PCT No.: PCT/JP2015/076447

§ 371 Date: Apr. 6, 2017

(30) Foreign Application Priority Data
Oct. 7, 2014 (JP) 2014-206527

(51) Int. Cl. H01M 10/0525; H01M 4/04; H01M 10/0566; H01M 4/505; H01M 4/525

(52) U.S. Cl. CPC H01M 10/0525; H01M 4/505; H01M 4/525; H01M 10/0566; H01M 4/04; H01M 2004/028

(57) ABSTRACT

A positive electrode active material for a lithium ion secondary battery that can suppress gas generation and that can provide a lithium ion secondary battery having a high capacity retention ratio in charge-discharge cycles is provided. The positive electrode active material for a lithium ion secondary battery according to the present exemplary embodiment includes a compound having a layered rock salt structure and represented by LiₓFeₛM¹_{(z-s)}M²_{y}O_{δ} (wherein 1.05≦x≦1.90, 0.05≦s≦0.50, 0.05≦z≦0.50, 0.33≦y≦0.90, 1.20≦δ≦3.10 and z−s≧0; M¹ is at least one element selected from the group consisting of Co and Ni; and M² is at least one element selected from the group consisting of Mn, Ti and Zr) and a specific 1,3-propanedione derivative.

### TECHNICAL FIELD

The present exemplary embodiment relates to a positive electrode active material for a lithium ion secondary battery, a method for manufacturing the same, and a lithium ion secondary battery.

### BACKGROUND ART

Due to a high energy density, small self-discharge, excellent long-term reliability and other advantages, lithium ion secondary batteries are in practical use as batteries for, for example, small electronic devices such as notebook computers and cell phones. Also, such lithium ion secondary batteries are increasingly applied to electric vehicles, household rechargeable batteries and power storage purposes.

However, in secondary batteries including a positive electrode, a negative electrode and a non-aqueous electrolytic solution, degradation products of the solvent in the electrolytic solution resulting from reductive degradation on the negative electrode surface build up on the negative electrode surface and increase resistance, and gas generated due to the degradation of the solvent results in expanded batteries. Also, degradation products of the solvent resulting from oxidative degradation on the positive electrode surface build up on the positive electrode surface and increase resistance, and gas generated due to the degradation of the solvent results in expanded batteries. As a result, problems arise including impaired storage characteristics of batteries and impaired cycle characteristics of secondary batteries, leading to impaired battery characteristics

One example of a method for solving the above problems is a method in which a compound that functions to form a protective film is added to the non-aqueous electrolytic solution. Specifically, the degradation of the compound added to the electrolytic solution is intentionally promoted on the electrode active material surface during initial charging, and the degradation product thereof forms a protective film having a protective function for preventing solvent degradation. The protective film having a protective function for preventing solvent degradation is called a solid electrolyte interface (SEI).

In Non Patent Literature 1, a protective film formed on the negative electrode surface by an additive appropriately suppresses the chemical reaction and degradation of the solvent on the electrode surface, and thus the battery characteristics of the secondary battery are maintained. Also, an electrode surface film forming agent for protecting the negative electrode surface is described in Patent Literature 1. However, these techniques do not sufficiently suppress gas generation resulting from the oxidative degradation of the solvent on the positive electrode.

Meanwhile, research has been carried out on the use of a high-potential positive electrode in order to achieve a secondary battery having a high energy density. Lithium ion secondary batteries in which a high-potential positive electrode is used are described in Patent Literatures 2 and 3, and these lithium ion secondary batteries have an electric potential of 4.5 V or more. Accordingly, compared with the voltage (3.5 to 4.2 V) of commonly used lithium ion secondary batteries, gas is more likely to be generated on the positive electrode due to the oxidative degradation of the solvent. Thus, there are demands for a technique that suppresses gas generation on the positive electrode in high-potential lithium ion secondary batteries.

Patent Literature 4 discloses a method in which a silane coupling agent and an epoxy resin are used to thereby form a protective film on the positive electrode surface to suppress gas generation from the positive electrode. Also, Patent Literature 5 discloses a method in which a boric acid compound is adhered to a positive electrode active material to thereby suppress gas generation from the positive electrode.

### CITATION LIST

### Patent Literature

Patent Literature 1: JP2002-124263A
Patent Literature 2: JP2013-254605A
Patent Literature 3: WO2012/141301
Patent Literature 4: JP2014-22276A
Patent Literature 5: JP2010-40382A

### Non Patent Literature

Non Patent Literature 1: Journal. Power Sources, No. 162, Vol. 2, pp. 1379-1394 (2006)

### SUMMARY OF INVENTION

### Technical Problem

However, a problem of the methods described in Patent Literatures 4 and 5 is that in lithium ion secondary batteries including a positive electrode having a high electric potential of 4.5 V or more in particular, gas generation from the positive electrode cannot be sufficiently suppressed, and also the capacity retention ratio in charge-discharge cycles is low.

An object of the present exemplary embodiment is to provide a positive electrode active material for a lithium ion secondary battery that can suppress gas generation and that can provide a lithium ion secondary battery having a high capacity retention ratio in charge-discharge cycles.

### Solution to Problem

The positive electrode active material for a lithium ion secondary battery according to the present exemplary embodiment includes:
a compound having a layered rock salt structure and represented by formula (1) below:

LiₓFeₛM¹_{(z-s)}M²_{y}O_{δ} (1)

wherein 1.05≦x≦1.90, 0.05≦s≦0.50, 0.05≦z≦0.50, 0.33≦y≦0.90, 1.20≦δ≦3.10 and z−s≧0; M¹ is at least one element selected from the group consisting of Co and Ni; and M² is at least one element selected from the group consisting of Mn, Ti and Zr; and

a 1,3-propanedione derivative represented by formula (2) below:

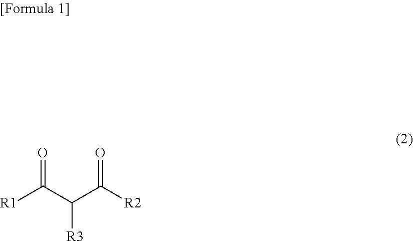

wherein R1 and R2 are each independently a substituted or unsubstituted alkyl group having 1 to 6 carbon atoms, a substituted or unsubstituted aryl group, or a substituted or unsubstituted heteroaryl group; and R3 is a hydrogen atom or a substituted or unsubstituted aryl group.

The lithium ion secondary battery according to the present exemplary embodiment includes a positive electrode including the above positive electrode active material for a lithium ion secondary battery.

The method for manufacturing a positive electrode active material for a lithium ion secondary battery according to the present exemplary embodiment includes immersing a particle including a compound having a layered rock salt structure and represented by formula (1) in a solution in which a 1,3-propanedione derivative represented by formula (2) is dissolved, to coat at least a part of the surface of the particle including the compound represented by formula (1) with the 1,3-propanedione derivative represented by formula (2).

### Advantageous Effects of the Invention

According to the present exemplary embodiment, a positive electrode active material for a lithium ion secondary battery can be provided that can suppress gas generation and that can provide a lithium ion secondary battery having a high capacity retention ratio in charge-discharge cycles.

### BRIEF DESCRIPTION OF DRAWING

FIG. 1 is a cross-sectional view showing one example of the configuration of a lithium ion secondary battery according to the present exemplary embodiment.

### DESCRIPTION OF EMBODIMENT

[Positive Electrode Active Material for a Lithium Ion Secondary Battery]

As a result of having conducted diligent research to solve the above-described problems, the inventors found that the use of a positive electrode active material containing a specific lithium oxide and a 1,3-propanedione derivative having a specific structure makes it possible to suppress gas generation from a positive electrode and achieve an excellent capacity retention ratio.

That is to say, the positive electrode active material for a lithium ion secondary battery according to the present exemplary embodiment contains:
a compound having a layered rock salt structure and represented by formula (1) below:

LiₓFeₛM¹_{(z-s)}M²_{y}O_{δ} (1)

wherein 1.05≦x≦1.90, 0.05≦s≦0.50, 0.05≦z≦0.50, 0.33≦y≦0.90, 1.20≦δ≦3.10 and z−s≧0; M¹ is at least one element selected from the group consisting of Co and Ni; and M² is at least one element selected from the group consisting of Mn, Ti and Zr; and

a 1,3-propanedione derivative represented by formula (2) below:

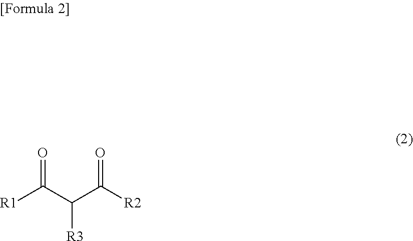

wherein R1 and R2 are each independently a substituted or unsubstituted alkyl group having 1 to 6 carbon atoms, a substituted or unsubstituted aryl group, or a substituted or unsubstituted heteroaryl group; and R3 is a hydrogen atom or a substituted or unsubstituted aryl group.

(Compound Represented by Formula (1))

The compound represented by formula (1) has a layered rock salt structure and provides a positive electrode having a high electric potential of 4.5 V or more when used as a positive electrode active material. Whether it has a layered rock salt structure or not is analyzed by X-ray diffraction measurement.

In formula (1), M¹ is at least one element selected from the group consisting of Co and Ni, and preferably contains Ni. M² is at least one element selected from the group consisting of Mn, Ti and Zr, preferably contains Mn or Ti, and more preferably contains Mn from the viewpoint of cost reduction.

In formula (1), x satisfies 1.05≦x≦1.90, preferably satisfies 1.10≦x≦1.80, more preferably satisfies 1.15≦x≦1.70, and even more preferably satisfies 1.20≦x≦1.60. s satisfies 0.05≦s≦0.50, preferably satisfies 0.08≦s≦0.40, more preferably satisfies 0.10≦s≦0.30, and even more preferably satisfies 0.15≦s≦0.25. z satisfies 0.05≦z≦0.50, preferably satisfies 0.15≦z≦0.48, more preferably satisfies 0.25≦z≦0.46, and even more preferably satisfies 0.35≦z≦0.45. y satisfies 0.33≦y≦0.90, preferably satisfies 0.40≦y≦0.85, more preferably satisfies 0.45≦y≦0.80, and even more preferably satisfies 0.50≦y≦0.70. δ satisfies 1.20≦δ≦3.10, preferably satisfies 1.50≦δ≦3.00, more preferably satisfies 1.80≦δ≦2.80, and even more preferably satisfies 2.20≦ε≦2.60. z and s satisfy z−s≧0.

Specific examples of the composition of the compound represented by formula (1) include Li_{1.4}Fe_{0.2}Ni_{0.2}Mn_{0.6}O_{2.4}, Li_{1.55}Fe_{0.5}Ni_{0.15}Ni_{0.15}Mn_{0.7}O_{2.55}, Li_{1.2}Fe_{0.20}Ni_{0.20}Mn_{0.40}O_{2.00}, Li_{1.23}Fe_{0.15}Ni_{0.15}Mn_{0.46}O_{2.00}, Li_{1.26}Fe_{0.11}Ni_{0.11}Mn_{0.52}O_{2.00}, Li_{1.29}Fe_{0.07}Ni_{0.14}Mn_{0.57}O_{2.00}, Li_{1.26}Fe_{0.22}Mn_{0.37}Ti_{0.15}O_{2.00}, Li_{1.5}Fe_{0.1}Ni_{0.1}Mn_{0.8}O_{2.8}, Li_{1.85}Fe_{0.05}Ni_{0.1}Mn_{0.85}O_{2.85} and Li_{1.9}Fe_{0.05}Ni_{0.05}Mn_{0.9}O_{3.1}.

The method for synthesizing the compound represented by formula (1) is not particularly limited, and a commonly used method for synthesizing an oxide having a layered rock salt structure is applicable.

(1,3-Propanedione Derivative Represented by Formula (2))

In formula (2), R1 and R2 are each independently a substituted or unsubstituted alkyl group having 1 to 6 carbon atoms, a substituted or unsubstituted aryl group, or a substituted or unsubstituted heteroaryl group. R3 is a hydrogen atom or a substituted or unsubstituted aryl group.

Examples of the substituted or unsubstituted alkyl group having 1 to 6 carbon atoms include a methyl group, an ethyl group, a propyl group, an isopropyl group, an n-butyl group, an isobutyl group, a t-butyl group, a pentyl group and an n-hexyl group. The alkyl group may have a substituent, and, for example, one or more hydrogen atoms may be each independently substituted with a fluorine atom, a cyano group, an ester group, an alkoxy group having 1 to 5 carbon atoms, an aryl group or a heteroaryl group. Examples of the substituted alkyl group include a trifluoromethyl group, a pentafluoroethyl group, a trifluoroethyl group, a heptafluoropropyl group, a cyanomethyl group, a benzyl group and a 2-thienylmethyl group.

Examples of the substituted or unsubstituted aryl group include a phenyl group, a naphthyl group, a tolyl group, a 4-cyanophenyl group, fluorophenyl groups such as a 2-fluorophenyl group, a 3-fluorophenyl group, a 4-fluorophenyl group, a 2,3-difluorophenyl group, a 2,4-difluorophenyl group, a 2,5-difluorophenyl group, a 2,6-difluorophenyl group, a 3,4-difluorophenyl group, a 3,5-difluorophenyl group, a 3,6-difluorophenyl group, a 2,4,6-trifluorophenyl group, and a pentafluorophenyl group and a 4-methoxyphenyl group.

Examples of the substituted or unsubstituted heteroaryl group include a 2-thienyl group, a 3-thienyl group, a 2-furanyl group, a 4-methyl-2-thienyl group and a 3-fluoro-2-thienyl group.

R1 and R2 are preferably a methyl group, a trifluoromethyl group, a pentafluoroethyl group, a phenyl group, a 2-thienyl group, a 2-furanyl group, fluorophenyl groups such as a 2-fluorophenyl group, a pentafluorophenyl group, a 4-fluorophenyl group, a 2,4-difluorophenyl group, a 3,4-difluorophenyl group, a 3,5-difluorophenyl group, and a 2,4,6-trifluorophenyl group, and a 4-cyanophenyl group, and are more preferably a 2-thienyl group, a 2-furanyl group or a fluorophenyl group from the viewpoint of suppressing gas generation.

R3 is preferably a hydrogen atom, a phenyl group, a 4-fluorophenyl group, a 2,4-difluorophenyl group and a pentafluorophenyl group.

Specific examples of the 1,3-propanedione derivative represented by formula (2) are shown in Table 1. Note that the 1,3-propanedione derivative represented by formula (2) according to the present exemplary embodiment is not limited to the compounds in Table 1.

TABLE 1

| Compound | Chemical Formula |
|---|---|
| PD1 | 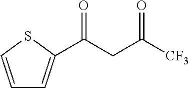 [SMILES: O=C(CC(=O)C(F)(F)F)c1cccs1] |
| PD2 | 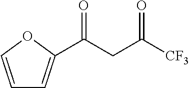 [SMILES: O=C(CC(=O)C(F)(F)F)c1ccco1] |
| PD3 | 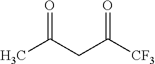 |
| PD4 | 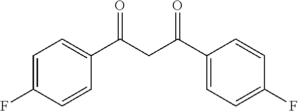 [SMILES: O=C(CC(=O)c1ccc(F)cc1)c1ccc(F)cc1] |
| PD5 | 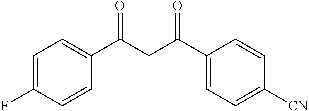 [SMILES: N#Cc1ccc(C(=O)CC(=O)c2ccc(F)cc2)cc1] |
| PD6 | 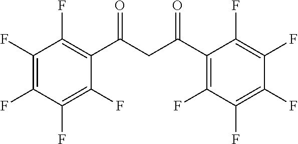 [SMILES: O=C(CC(=O)c1c(F)c(F)c(F)c(F)c1F)c1c(F)c(F)c(F)c(F)c1F] |
| PD7 | 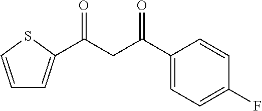 [SMILES: O=C(CC(=O)c1cccs1)c1ccc(F)cc1] |
| PD8 | 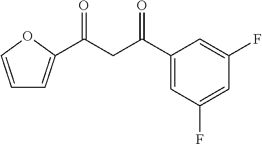 [SMILES: O=C(CC(=O)c1ccco1)c1cc(F)cc(F)c1] |
| PD9 | 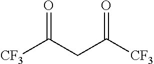 [SMILES: O=C(CC(=O)C(F)(F)F)C(F)(F)F] |
| PD10 | 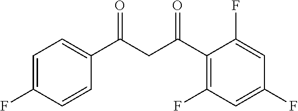 [SMILES: O=C(CC(=O)c1c(F)cc(F)cc1F)c1ccc(F)cc1] |
| PD11 | 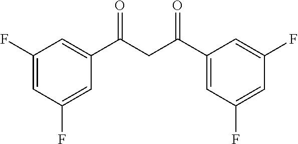 [SMILES: O=C(CC(=O)c1cc(F)cc(F)c1)c1cc(F)cc(F)c1] |
| PD12 | 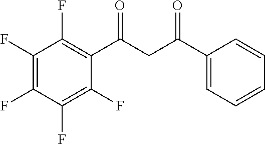 [SMILES: O=C(CC(=O)c1c(F)c(F)c(F)c(F)c1F)c1ccccc1] |
| PD13 | 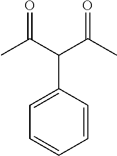 |

One of these 1,3-propanedione derivatives represented by formula (2) may be used singly, or two or more may be used in combination.

At least a part of the surface of a particle containing the compound represented by formula (1) is preferably coated with the 1,3-propanedione derivative represented by formula (2). With at least a part of the surface of the particle containing the compound represented by formula (1) being coated with the 1,3-propanedione derivative represented by formula (2), the chemical reaction and the degradation of an electrolytic solution on the positive electrode surface are suppressed, thus gas generation from the positive electrode is suppressed, and the long-term reliability and the life of a secondary battery are improved. As a result, a lithium ion secondary battery having a large capacity, a high energy density, and an excellent charge-discharge cycle stability is obtained. The particle containing the compound represented by formula (1) is preferably a particle consisting of the compound represented by formula (1).

The coating ratio is not particularly limited. Although it is sufficient that at least a part of the surface of the particle containing the compound represented by formula (1) is coated with the 1,3-propanedione derivative represented by formula (2), preferably the most of or the entirety of the surface of the particle containing the compound represented by formula (1) is coated with the 1,3-propanedione derivative represented by formula (2).

The 1,3-propanedione derivative represented by formula (2) in a solution is present in a keto form represented by formula (2) or an enol form (an isomer) represented by formula (3) below.

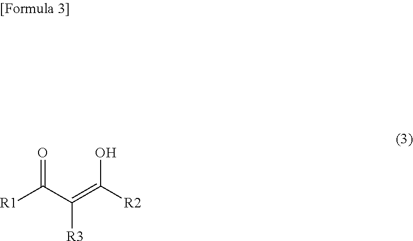

The enol form represented by formula (3) binds to a metal ion (Mⁿ⁺) to form a complex as shown in formula (4) below on the surface of the particle containing the compound represented by formula (1). As a result, the surface of the particle containing the compound represented by formula (1) is coated with the 1,3-propanedione derivative represented by formula (2).

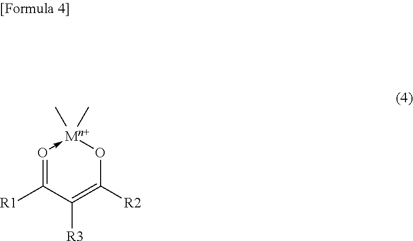

In the present exemplary embodiment, it is sufficient that the 1,3-propanedione derivative represented by formula (2) is attached to the surface of the particle containing the compound represented by formula (1), and the surface of the particle containing the compound represented by formula (1) does not necessarily need to be coated therewith. That is to say, it is sufficient that the compound represented by formula (1) and the 1,3-propanedione derivative represented by formula (2) are contained in the positive electrode active material according to the present exemplary embodiment. For example, even when the surface of the particle containing the compound represented by formula (1) is initially coated with the 1,3-propanedione derivative represented by formula (2), the present exemplary embodiment also encompasses a case where the 1,3-propanedione derivative represented by formula (2) is detached from the surface during the manufacturing process of, or the course of using a lithium ion secondary battery.

The content of the 1,3-propanedione derivative represented by formula (2) in the positive electrode active material for a lithium ion secondary battery according to the present exemplary embodiment is preferably 0.01 to 10% by mass, and more preferably 0.1 to 5% by mass. The content is a value determined from the amount of the unreacted 1,3-propanedione derivative in the reaction for coating the positive electrode with the 1,3-propanedione derivative.

[Method for Manufacturing Positive Electrode Active Material for a Lithium Ion Secondary Battery]

The method for manufacturing a positive electrode active material for a lithium ion secondary battery according to the present exemplary embodiment includes immersing a particle containing a compound represented by formula (1) in a solution in which a 1,3-propanedione derivative represented by formula (2) is dissolved, to coat at least a part of the surface of the particle containing the compound represented by formula (1) with the 1,3-propanedione derivative represented by formula (2). According to the method of the present exemplary embodiment, at least a part of the surface of the particle containing the compound represented by formula (1) can be easily coated with the 1,3-propanedione derivative represented by formula (2).

A solution in which the 1,3-propanedione derivative represented by formula (2) is dissolved can be obtained by, for example, dissolving the 1,3-propanedione derivative represented by formula (2) in a non-aqueous solvent such as a chain carbonate, a chain ester, a lactone, an ether, or a nitrile.

Examples of the chain carbonate include dimethyl carbonate, diethyl carbonate, dipropyl carbonate and ethyl methyl carbonate. Examples of the chain ester include methyl acetate, ethyl acetate, methyl propionate and ethyl propionate. Examples of the lactone include γ-butyrolactone, δ-valerolactone and α-methyl-γ-butyrolactone. Examples of the ether include tetrahydrofuran, 2-methyltetrahydrofuran, 1,3-dioxolane, 1,3-dioxane, 1,4-dioxane, 1,2-dimethoxyethane, 1,2-diethoxyethane and 1,2-dibutoxyethane. Examples of the nitrile include acetonitrile and propionitrile. One of these non-aqueous solutions may be used singly, or two or more may be used in combination.

The content of the 1,3-propanedione derivative represented by formula (2) in the solution in which the 1,3-propanedione derivative represented by formula (2) is dissolved is preferably 0.05 to 10% by mass, and more preferably 0.1 to 5% by mass.

A particle containing the compound represented by formula (1) is added to the solution in which the 1,3-propanedione derivative represented by formula (2) is dissolved. Thereafter, stirring is performed at room temperature to 60° C. for 1 hour to 24 hours, the positive electrode active material is separated by filtration, washed with a non-aqueous solution, and vacuum-dried at room temperature to 100° C., and thus a positive electrode active material for a lithium ion secondary battery is obtained in which at least a part of the surface of the particle containing the compound represented by formula (1) is coated with the 1,3-propanedione derivative represented by formula (2).

[Lithium Ion Secondary Battery]

The lithium ion secondary battery according to the present exemplary embodiment includes a positive electrode containing the above positive electrode active material for a lithium ion secondary battery. The lithium ion secondary battery can include a negative electrode containing a material capable of intercalating and deintercalating lithium ions, and an electrolytic solution. The structure of the lithium ion secondary battery is not particularly limited, and examples include a coin battery, a cylindrical battery, and a laminate battery that have a single layer of or multiple layers of a separator.

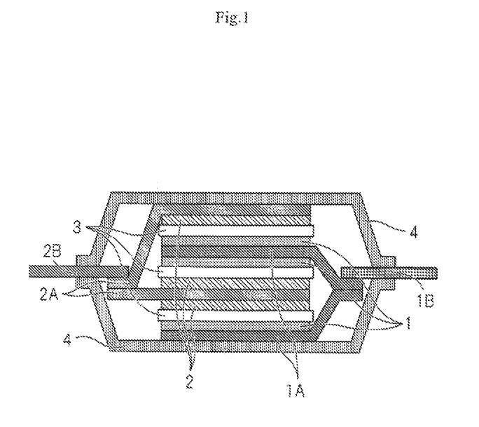

FIG. 1 shows one example of the lithium ion secondary battery according to the present exemplary embodiment. In the lithium ion secondary battery shown in FIG. 1, a positive electrode active material layer 1 containing the positive electrode active material for a lithium ion secondary battery according to the present exemplary embodiment is formed on a positive electrode current collector 1A, and thereby a positive electrode is fabricated. Also, a negative electrode active material layer 2 is formed on a negative electrode current collector 2A, and thereby a negative electrode is fabricated. Being immersed in an electrolytic solution, the positive electrode and the negative electrode are laminated so as to face each other, with a separator 3 in-between. Also, the positive electrode is connected to a positive electrode tab 1B, and the negative electrode is connected to a negative electrode tab 2B. This battery element is accommodated in an outer package 4, and the positive electrode tab 1B and the negative electrode tab 2B are exposed to the outside.

(Positive Electrode)

In the present exemplary embodiment, the positive electrode can include, for example, a positive electrode active material layer containing a positive electrode active material and a positive electrode binder, and a positive electrode current collector.

The positive electrode active material contains the positive electrode active material for a lithium ion secondary battery according to the present exemplary embodiment, and one can be used singly or two or more can be used in combination.

The positive electrode binder is not particularly limited, and examples include polyvinylidene fluoride, a vinylidene fluoride-hexafluoropropylene copolymer, a vinylidene fluoride-tetrafluoroethylene copolymer, styrene-butadiene copolymer rubber, polytetrafluoroethylene, polypropylene, polyethylene, polyimide, and polyamide imide. In particular, from the viewpoint of versatility and low cost, polyvinylidene fluoride is preferably used as a positive electrode binder. The amount of the positive electrode binder used is preferably 2 to 10 parts by mass based on 100 parts by mass of the positive electrode active material from the viewpoint of a trade-off between “sufficient binding strength” and “high energy”.

For example, aluminum foil, a stainless-steel lath, or the like can be used as a positive electrode current collector.

The positive electrode active material layer may contain an electroconductive auxiliary to lower impedance. Examples of the electroconductive auxiliary include graphites such as natural graphite and artificial graphite, and carbon blacks such as acetylene black, Ketchen black, furnace black, channel black, and thermal black. A plurality of electroconductive auxiliaries may be suitably mixed and used. The amount of the electroconductive auxiliary added is preferably 1 to 10 parts by mass based on 100 parts by mass of the positive electrode active material.

The positive electrode can be prepared by, for example, adding a solvent such as N-methylpyrrolidone to a mixture of the positive electrode active material, the electroconductive auxiliary and the binder, kneading the mixture, applying the mixture to the positive electrode current collector by a doctor blade method, a die coater method or the like, and drying the mixture.

(Negative Electrode)

In the present exemplary embodiment, the negative electrode can include, for example, a negative electrode active material layer containing a negative electrode active material and a negative electrode binder, and a negative electrode current collector.

Examples of the negative electrode active material include lithium metal, a metal capable of alloying with lithium or an alloy, an oxide capable of intercalating and deintercalating lithium, and carbon.

Examples of the metal capable of alloying with lithium or the alloy include lithium-silicon and lithium-tin. Examples of the oxide capable of intercalating and deintercalating lithium include niobium pentoxide (Nb₂O₅), lithium titanium composite oxide (Li_{4/3}Ti_{5/3}O₄) and titanium dioxide (TiO₂). Examples of the carbon include graphite materials, carbon black, coke, mesocarbon microbeads, hard carbon and graphite. Examples of the graphite materials include artificial graphite and natural graphite. Examples of the carbon black include acetylene black and furnace black. Among these, carbon is preferable from the viewpoint of good cycle characteristics and safety as well as excellent continuous-charge characteristics.

Also, in the present exemplary embodiment, a silicon-containing negative electrode active material may be used. Examples of the silicon-containing negative electrode active material include silicon and silicon compounds. Examples of the silicon compounds include silicon oxide, silicate, and compounds of a transition metal and silicon such as nickel silicide and cobalt silicide. One of these may be used singly, or two or more may be used in combination.

Among these, at least one selected from the group consisting of silicon, silicon oxide and carbon is preferably used as a negative electrode active material from the viewpoint of battery capacity and stable operation.

The silicon compound lessens the expansion and contraction of the negative electrode active material itself caused by repetitive charge-discharge, and is thus preferably used from the viewpoint of charge-discharge cycle characteristics. Moreover, the silicon compound functions to ensure conduction through silicon depending on the type of silicon compound. From these viewpoints, silicon oxide is preferable as the silicon compound. Silicon oxide is not particularly limited, and examples include oxides represented by SiOₓ (0<x≦2). Silicon oxide may contain Li. Li-containing silicon oxide is represented by, for example, SiLi_{y}O_{z} (0<y, 0<z<2).

Also, silicon oxide may contain a small amount of another metal element or non-metal element. Silicon oxide can contain one or two or more elements selected from, for example, nitrogen, boron and sulfur in a proportion of, for example, 0.1 to 5% by mass. Due to the small amount of another metal element or non-metal element contained in silicon oxide, the electroconductivity of silicon oxide is increased. Also, silicon oxide may be crystalline or may be amorphous.

Also, when the negative electrode active material contains silicon or silicon oxide, preferably the negative electrode active material further contains carbon that is capable of intercalating and deintercalating lithium ions. Carbon may be in the form of a composite with silicon or silicon oxide. As with silicon oxide, carbon functions to lessen the expansion and contraction of the negative electrode active material itself caused by repetitive charge-discharge and ensure conduction through silicon. In particular, when the negative electrode active material contains silicon, silicon oxide and carbon, better cycle characteristics are obtained.

Graphite, amorphous carbon, diamond-like carbon, a carbon nanotube and the like can be used as carbon. Graphite, which is highly crystalline, is highly electroconductive, and has excellent adhesion to a positive electrode current collector composed of a metal such as copper as well as voltage flatness. On the other hand, amorphous carbon, which has low crystallinity, shows relatively small volume expansion, thus can lessen the volume expansion of the entire negative electrode, and is unlikely to undergo degradation resulting from non-uniformity such as grain boundaries and defects. The carbon content in the negative electrode active material is preferably 2% by mass or more and 50% by mass or less, and more preferably 2% by mass or more and 30% by mass or less.

A negative electrode active material containing silicon and a silicon compound when silicon oxide is used as the silicon compound can be prepared by, for example, mixing silicon and silicon oxide and sintering the mixture at high temperature under reduced pressure. Also, when a compound of a transition metal and silicon is used as the silicon compound, the negative electrode active material can be prepared by, for example, mixing silicon and a transition metal and fusing the mixture, or coating the surface of silicon with the transition metal by vapor deposition or the like.

When forming a composite with carbon, for example, a coating layer containing carbon around the nuclei of silicon and silicon oxide can be formed by introducing a mixed sintered material of silicon and a silicon compound into a gaseous atmosphere of an organic compound in a high-temperature, non-oxygen atmosphere. Also, for example, a coating layer containing carbon around the nuclei of silicon and silicon oxide can be formed by mixing a mixed sintered material of silicon and a silicon oxide with a carbon precursor resin in a high-temperature, non-oxygen atmosphere. Thus, by forming a coating layer containing carbon around the nuclei of silicon and silicon oxide, further improvement effects are obtained on the suppression of volume expansion caused by charge-discharge and on cycle characteristics.

When silicon is used as a negative electrode active material, the negative electrode active material is preferably a composite containing silicon, silicon oxide and carbon (hereinafter also referred to as a Si/SiO/C composite).

Moreover, the entirety of or a part of silicon oxide preferably has an amorphous structure. Silicon oxide having an amorphous structure can suppress the volume expansions of carbon and silicon. Although the mechanism thereof is not clear, it is presumed that the amorphous structure of silicon oxide has a certain influence on the formation of a film at the interface between carbon and an electrolytic solution. Also, the amorphous structure is considered to have relatively fewer factors resulting from non-uniformity such as grain boundaries and defects.

X-ray diffraction measurement can reveal that the entirety of or a part of silicon oxide has an amorphous structure. When silicon oxide does not have an amorphous structure, a peak specific to silicon oxide is intensely observed in X-ray diffraction measurement. On the other hand, when the entirety of or a part of silicon oxide has an amorphous structure, the peak specific to silicon oxide is broad in X-ray diffraction measurement.

In the Si/SiO/C composite, the entirety of or a part of silicon is preferably dispersed in silicon oxide. By dispersing at least a part of silicon in silicon oxide, the volume expansion of the negative electrode as a whole can be more suppressed, and also the degradation of an electrolytic solution can be suppressed. Transmission electron microscope observation and energy dispersive X-ray spectroscope measurement in combination can reveal that the entirety of or a part of silicon is dispersed in silicon oxide. Specifically, a cross-section of a sample is observed by a transmission electron microscope, and the oxygen concentration of silicon portions dispersed in silicon oxide is measured by energy dispersive X-ray spectroscope measurement. As a result, it can be revealed that silicon dispersed in silicon oxide is not an oxide.

In the Si/SiO/C composite, for example, the entirety of or a part of silicon oxide has an amorphous structure, and the entirety of or a part of silicon is dispersed in silicon oxide. Such a Si/SiO/C composite can be prepared by, for example, a method as disclosed in JP2004-47404A. That is to say, the Si/SiO/C composite can be obtained by, for example, performing a CVD treatment on silicon oxide in an atmosphere containing an organic gas such as methane gas. In the Si/SiO/C composite obtained by the method, the surface of a particle composed of silicon-containing silicon oxide is coated with carbon. Also, silicon is nano-clustered in silicon oxide.

In the Si/SiO/C composite, the proportions of silicon, silicon oxide, and carbon are not particularly limited, and the following proportions are preferable. Silicon is preferably contained in a proportion of 5% by mass or more and 90% by mass or less, and more preferably contained in a proportion of 20% by mass or more and 50% by mass or less based on the Si/SiO/C composite. Silicon oxide is preferably contained in a proportion of 5% by mass or more and 90% by mass or less, and more preferably contained in a proportion of 40% by mass or more and 70% by mass or less based on the Si/SiO/C composite. Carbon is preferably contained in a proportion of 2% by mass or more and 50% by mass or less, and more preferably contained in a proportion of 2% by mass or more and 30% by mass or less based on the Si/SiO/C composite.

Also, the Si/SiO/C composite may be a mixture of silicon, silicon oxide and carbon. For example, the Si/SiO/C composite can be prepared by mixing particulate silicon, particulate silicon oxide and particulate carbon by mechanical milling.

The average particle size of silicon is preferably smaller than the average particle sizes of carbon and silicon oxide. Accordingly, silicon, the volume change of which during charge-discharge is large, has a relatively small particle size, and carbon and silicon oxide, the volume change of which is small, have a relatively large particle size, and thus dendrite formation and the reduction of the particle size of alloy are suppressed. Also, during the course of charge-discharge, lithium is intercalated into and deintercalated from particles having a large particle size, particles having a small particle size, and particles having a large particle size in this order, and from this point as well, generation of residual stress and residual deformation are suppressed.

The average particle size of silicon is preferably 20 μm or less, and more preferably 15 μm or less. The average particle size of silicon oxide is preferably equal to or less than ½ of the average particle size of carbon. The average particle size of silicon is preferably equal to or less than ½ of the average particle size of silicon oxide. More preferably, the average particle size of silicon oxide is equal to or less than ½ of the average particle size of carbon, and at the same time the average particle size of silicon is equal to or less than ½ of the average particle size of silicon oxide. Controlling the average particle sizes to the above ranges makes it possible to more effectively obtain the effect of lessening the volume expansion, and thus makes it possible to obtain a secondary battery having an excellent balance of energy density, cycle life and efficiency. More specifically, it is preferable that graphite is used as carbon, the average particle size of silicon oxide is equal to or less than ½ of the average particle size of graphite, and the average particle size of silicon is equal to or less than ½ of the average particle size of silicon oxide. The average particle size is measured by a laser diffraction/scattering method or a dynamic light scattering method.

A negative electrode active material obtained by treating the surface of the above-described Si/SiO/C composite with a silane coupling agent or the like may be used. The negative electrode active material layer preferably contains the negative electrode active material in a proportion of 55% by mass or more, and more preferably 65% by mass or more.

The negative electrode binder is not particularly limited, and, for example, polyvinylidene fluoride, a vinylidene fluoride-hexafluoropropylene copolymer, a vinylidene fluoride-tetrafluoroethylene copolymer, styrene-butadiene copolymer rubber (SBR), polytetrafluoroethylene, polypropylene, polyethylene, polyimide, polyamide imide, polyacrylic acid or carboxymethyl cellulose including a lithium salt, a sodium salt or a potassium salt neutralized with an alkali, or the like can be used. One of these may be used singly, or two or more may be used in combination. Among these, polyimide, polyamide imide, SBR, or polyacrylic acid or carboxymethyl cellulose including a lithium salt, a sodium salt or a potassium salt neutralized with an alkali is preferable because of strong adhesion. The amount of the negative electrode binder used is preferably 5 to 25 parts by mass based on 100 parts by mass of the negative electrode active material from the viewpoint of a trade-off between “sufficient binding strength” and “high energy”.

As a material of the negative electrode current collector, for example, a metal material such as copper, nickel or stainless-steel is used. Among these, copper is preferable in terms of processability and cost. Also, it is preferable to perform a surface roughening treatment on the surface of the negative electrode current collector in advance. Examples of the shape of the negative electrode current collector include a foil shape, a plate shape and a mesh shape. Also, a perforated current collector such as an expanded metal or a punched metal can be used as well.

The negative electrode can be produced in the same manner as the positive electrode. For example, the negative electrode can be produced by adding a solvent to a mixture of a negative electrode active material, a negative electrode binder, and optional various auxiliaries and the like, kneading the mixture, applying the resulting slurry to a negative electrode current collector, and drying the slurry.

(Electrolytic Solution)

The electrolytic solution according to the present exemplary embodiment can contain a non-aqueous solvent and an electrolyte salt. Examples of the non-aqueous solvent include cyclic carbonates, chain carbonates, chain esters, lactones, ethers, sulfones, nitriles, and phosphoric acid esters.

Specific examples of the cyclic carbonates include propylene carbonate, ethylene carbonate, fluoroethylene carbonate, butylene carbonate, vinylene carbonate and vinyl ethylene carbonate.

Specific examples of the chain carbonates include dimethyl carbonate, diethyl carbonate, dipropyl carbonate, dibutyl carbonate, ethyl methyl carbonate, methyl propyl carbonate, methyl isopropyl carbonate and methyl butyl carbonate.

Specific examples of the chain esters include methyl formate, methyl acetate, methyl propionate, ethyl propionate, methyl pivalate and ethyl pivalate.

Specific examples of the lactones include γ-butyrolactone, δ-valerolactone and α-methyl-γ-butyrolactone.

Specific examples of the ethers include tetrahydrofuran, 2-methyltetrahydrofuran, 1,3-dioxolane, 1,3-dioxane, 1,4-dioxane, 1,2-dimethoxyethane, 1,2-diethoxyethane and 1,2-dibutoxyethane.

Specific examples of the sulfones include sulfolane, 3-methylsulfolane and 2,4-dimethylsulfolane.

Specific examples of the nitriles include acetonitrile, propionitrile, succinonitrile, glutaronitrile and adiponitrile.

Specific examples of the phosphoric acid esters include trimethyl phosphate, triethyl phosphate, tributyl phosphate and trioctyl phosphate.

One of these non-aqueous solvents can be used singly, or two or more can be used in combination. Examples of combinations of multiple non-aqueous solvents include combinations of cyclic carbonates and chain carbonates. Moreover, a fluorinated ether, a chain ester, a lactone, an ether, a nitrile, a sulfone, a phosphoric acid ester or the like may be added to a combination of a cyclic carbonate and a chain carbonate. Among these, from the viewpoint of being able to achieve excellent battery characteristics, the non-aqueous solvent preferably contains at least one of the chain carbonate solvent and the cyclic carbonate solvent.

Specific examples of the electrolyte salt include LiPF₆, LiBF₄, LiC₁₀O₄, LiN(SO₂F)₂, LiN(SO₂CF₃)₂, LiN(SO₂C₂F₅)₂, CF₃SO₃Li, C₄F₉SO₃Li, LiAsF₆, LiAlCl₄, LiSbF₆, LiPF₄(CF₃)₂, LiPF₃(C₂F₅)₃, LiPF₃(CF₃)₃, (CF₂)₂(SO₂)₂NLi, (CF₂)₃(SO₂)₂Li, lithium bis(oxalate)borate and lithium oxaltodifluoroborate. Among these, LiPF₆, LiBF₄, LiN(SO₂F)₂, LiN(SO₂CF₃)₂ and LiN(SO₂C₂F₅)₂ are preferable. One of these electrolyte salts can be used singly, or two or more can be used in combination.

The concentration of the electrolyte salt in the electrolytic solution is preferably 0.1 to 3 mol/L, and more preferably 0.5 to 2 mol/L.

Also, the electrolytic solution can optionally contain a commonly used component as a further component. Examples of the further component include maleic anhydride, ethylene sulfite, boronic acid ester, 1,3-propanesultone and 1,5,2,4-dioxadithian-2,2,4,4-tetraoxide.

(Separator)

The separator is not particularly limited, and, for example, a single-layer or multilayer porous film composed of polyolefin such as polypropylene or polyethylene, non-woven fabric, polyolefin coated with a different type of material, a laminated film and the like can be used. One example of polyolefin coated with a different type of material is a polyolefin substrate coated with a fluorine compound or inorganic fine particles. One example of laminated film is a film obtained by laminating a polyolefin substrate and an aramid layer. From the viewpoint of the energy density of a secondary battery and the mechanical strength of the separator, the thickness of the separator is preferably 5 to 50 μm, and more preferably 10 to 40 μm.

(Outer Package)

For example, a laminate film can be used as an outer package. A laminate film that is stable in the electrolytic solution and has sufficient water-vapor barrier properties can be suitably selected. For example, a laminate film composed of polypropylene, polyethylene or the like that is coated with aluminum, silica or alumina can be used. In particular, from the viewpoint of suppressing volume expansion, an aluminum-containing laminate film is preferably used.

A representative example of the layer configuration of the laminate film is a configuration in which a metal thin film layer and a heat-fusible resin layer are laminated. Also, in this configuration, a protective layer composed of a film of polyester such as polyethylene terephthalate or polyamide may be further laminated on the surface of the metal thin film layer on the side opposite the surface in contact with the heat-fusible resin layer. In this configuration, when sealing the battery element, the battery element is surrounded such that the heat-fusible resin layer faces the battery element. As the metal thin film layer, for example, a foil having a thickness of 10 to 100 μm composed of Al, Ti, Ti alloy, Fe, stainless steel or Mg alloy is used.

The resin contained in the heat-fusible resin layer is not particularly limited as long as it is heat-fusible. Examples of the resin include polypropylene, polyethylene, acid modified products of polypropylene or polyethylene, polyphenylene sulfide, polyester such as polyethylene terephthalate, polyamide, and an ethylene-vinyl acetate copolymer. Also, an ionomer resin obtained by intermolecular-bonding an ethylene-methacrylic acid copolymer or an ethylene-acrylic acid copolymer by metal ions can be used as well. The thickness of the heat-fusible resin layer is preferably 10 to 200 μm and more preferably 30 to 100 μm.

### EXAMPLES

### Synthesis Example 1

Synthesis of Lithium Oxide Coated with 1,3-Propanedione Derivative PD1

0.8 g of 1,3-propanedione derivative PD1 (2-thenoyltrifluoroacetone) shown in Table 1 above was dissolved in 80 ml of diethyl carbonate (DEC). 50 g of lithium oxide (Li_{1.4}Fe_{0.2}Ni_{0.2}Mn_{0.6}O_{2.4}) having a layered rock salt structure was added to DEC in which 1,3-propanedione derivative PD1 had been dissolved, and stirring was performed at room temperature for 17 hours. Lithium oxide was separated from the solution by filtration, washed with DEC, and vacuum-dried at 60° C. for 8 hours. Thereby, lithium oxide coated with 1,3-propanedione derivative PD1 was obtained.

### Synthesis Example 2

Synthesis of Lithium Oxide Coated with 1,3-Propanedione Derivative PD2

Lithium oxide coated with 1,3-propanedione derivative PD2 was obtained in the same manner as Synthesis Example 1 except that 1,3-propanedione derivative PD2 (2-floyltrifluoroacetone) shown in Table 1 above was used in place of 1,3-propanedione derivative PD1.

### Synthesis Example 3

Synthesis of Lithium Oxide Coated with 1,3-Propanedione Derivative PD4

Lithium oxide coated with 1,3-propanedione derivative PD4 was obtained in the same manner as Synthesis Example 1 except that 1,3-propanedione derivative PD4 (1,3-bis(4-fluorophenyl)-1,3-propanedione) shown in Table 1 above was used in place of 1,3-propanedione derivative PD1.

### Example 1

<Positive Electrode>

A slurry containing 92 parts by mass of lithium oxide coated with 1,3-propanedione derivative PD1 obtained in Synthesis Example 1, 4 parts by mass of Ketchen black, and 4 parts by mass of polyvinylidene fluoride was prepared. The slurry was applied to a positive electrode current collector composed of aluminum foil (thickness 20 μm) and dried to prepare a positive electrode having a thickness of 175 μm. Also, a double-sided electrode obtained by applying the slurry to both surfaces of the positive electrode current collector and drying the slurry was prepared through the same procedure.

<Negative Electrode>

A slurry containing 85 parts by mass of SiO having an average particle size of 15 μm and 15 parts by mass of polyamic acid was prepared. The slurry was applied to a negative electrode current collector composed of copper foil (thickness 10 μm) and dried to prepare a negative electrode having a thickness of 46 μm. The negative electrode was annealed in a nitrogen atmosphere at 350° C. for 3 hours to cure the polyamic acid binder.

<Electrolytic Solution>

A solvent was prepared in which ethylene carbonate (EC) and diethyl carbonate (DEC) were mixed in a volume ratio of 30:70. 1.0 mol/L of LiPF₆ was dissolved in the solvent to prepare an electrolytic solution.

<Lithium Ion Secondary Battery Before Activation Treatment>

After shaping the positive electrode and the negative electrode prepared by the above methods, the battery element shown in FIG. 1 was prepared. A separator 3, which is a porous-film, was sandwiched between the positive electrode including a positive electrode active material layer 1 and a positive electrode current collector 1A and the negative electrode including a negative electrode active material layer 2 and a negative electrode current collector 2A. A positive electrode tab 1B and a negative electrode tab 2B were welded to the positive electrode current collector 1A and the negative electrode collector 2A, respectively. The prepared battery element was wrapped with an outer package 4, which is an aluminum laminate film, and after three sides of the outer package 4 were sealed by heat sealing, the battery element was impregnated with the electrolytic solution in an appropriate degree of vacuum. Thereafter, the one side of the outer package 4 not yet heat-sealed was sealed by heat sealing to prepare a lithium ion secondary battery that was before activation treatment.

<Activation Treatment>

The prepared lithium ion secondary battery before activation treatment was charged to 4.5 V at an electric current of 20 mA per gram of the positive electrode active material (20 mA/g). Thereafter, it was discharged to 1.5 V at an electric current of 20 mA per gram of the positive electrode active material (20 mA/g). Thereafter, similarly, it was charged to 4.5 V at an electric current of 20 mA/g and then discharged to 1.5 V at an electric current of 20 mA/g. That is to say, activation treatment in which a charge-discharge cycle was repeated twice was performed. Thereafter, gas inside the battery was released by breaking a sealed portion to reduce pressure, and, moreover, the broken portion was resealed to thereby prepare a lithium ion secondary battery.

### Example 2

A lithium ion secondary battery was prepared in the same manner as Example 1 except that the positive electrode was prepared by using the lithium oxide coated with 1,3-propanedione derivative PD2 obtained in Synthesis Example 2 in place of the lithium oxide coated with 1,3-propanedione derivative PD1 obtained in Synthesis Example 1.

### Example 3

A lithium ion secondary battery was prepared in the same manner as Example 1 except that the positive electrode was prepared by using the lithium oxide coated with 1,3-propanedione derivative PD4 obtained in Synthesis Example 3 in place of the lithium oxide coated with 1,3-propanedione derivative PD1 obtained in Synthesis Example 1.

### Comparative Example 1

A lithium ion secondary battery was prepared in the same manner as Example 1 except that the positive electrode was prepared by using lithium oxide having a layered rock salt structure (Li_{1.4}Fe_{0.2}Ni_{0.2}Mn_{0.6}O_{2.4}) on which no coating treatment was performed in place of the lithium oxide coated with 1,3-propanedione derivative PD1 obtained in Synthesis Example 1.

<Method for Evaluating Lithium Ion Secondary Batteries>

The lithium ion secondary batteries prepared by the above method were charged to 4.5 V at a constant electric current of 40 mA/g in a thermostat at 45° C., and charging was further continued at a constant voltage of 4.5 V until the electric current became 5 mA/g. Thereafter, discharging was performed to 1.5 V at an electric current of 5 mA/g to calculate the initial capacities of the lithium ion secondary batteries.

Thereafter, the lithium ion secondary batteries after initial-capacity measurement were charged to 4.5 V at a constant electric current of 40 mA/g in a thermostat at 45° C., and charging was further continued at a constant voltage of 4.5 V until the electric current became 5 mA/g. Thereafter, discharging was performed to 1.5 V at an electric current of 40 mA/g. This charge-discharge cycle was repeated 30 times in total. The capacity retention ratio after 30 cycles was calculated from the ratio between the initial capacity obtained in the first cycle and the discharge capacity obtained in the 30th cycle. The amount of generated gas after 30 cycles was calculated for each Example and Comparative Example.

<Results of Evaluating Lithium Ion Batteries>

The 1,3-propanedione derivatives used in the respective Examples and Comparative Example, lithium oxide, initial capacity, capacity retention ratio after 30 cycles, and amount of generated gas after 30 cycles are shown in Table 2. The amount of generated gas is indicated as a converted value, with the amount of generated gas of Comparative Example 1 being 100.

TABLE 2

| | | | Initial | Capacity | Amount of |
|---|---|---|---|---|---|
| | | | capacity | retention | generated |
| | 1,3-propanedione derivative | Lithium oxide | (mAh/g) | ratio (%) | gas |
| Example 1 | PD1 | Li_{1.4}Fe_{0.2}Ni_{0.2}Mn_{0.6}O_{2.4} | 248 | 72 | 68 |
| | (2-thenoyltrifluoroacetone) | | | | |
| Example 2 | PD2 | Li_{1.4}Fe_{0.2}Ni_{0.2}Mn_{0.6}O_{2.4} | 249 | 70 | 70 |
| | (2-floyltrifluoroacetone) | | | | |
| Example 3 | PD4 | Li_{1.4}Fe_{0.2}Ni_{0.2}Mn_{0.6}O_{2.4} | 247 | 75 | 65 |
| | (1,3-bis(4-fluorophenyl)- | | | | |
| | 1,3-propanedione) | | | | |
| Comparative | none | Li_{1.4}Fe_{0.2}Ni_{0.2}Mn_{0.6}O_{2.4} | 243 | 58 | 100 |
| Example 1 | | | | | |

In reference to Table 2, it was observed that the capacity retention ratio is 10% or more higher in Examples 1 to 3 than Comparative Example 1. Also, it was observed that the amount of generated gas in Examples 1 to 3 was reduced to about 65 to 70% of Comparative Example 1. Accordingly, it was observed from the comparison between Examples 1 to 3 and Comparative Example 1 that the amount of generated gas during the cycle of a lithium ion secondary battery can be suppressed, and a high capacity is stably obtained, by using a positive electrode active material obtained by coating a specific lithium oxide with a specific 1,3-propanedione derivative.

As described above, a lithium ion secondary battery in which the positive electrode active material obtained by coating a specific lithium oxide with a specific 1,3-propanedione derivative according to the present invention is used has excellent characteristics that gas generation during the cycle can be suppressed, and a high capacity is stably obtained.

The present application claims priority to Japanese Patent Application No. 2014-206527 filed on Oct. 7, 2014, the entire disclosure of which is incorporated herein by reference.

The present invention has been described above in reference to exemplary embodiments and examples, but the present invention is not limited to the above exemplary embodiments and examples. Various modifications can be made to the configurations and details of the present invention within the scope of the present invention as can be understood by those skilled in the art.

### INDUSTRIAL APPLICABILITY

The positive electrode active material for a lithium ion secondary battery and the lithium ion secondary battery according to the present exemplary embodiment can be utilized in, for example, any industrial field where a power source is required and industrial field relating to the transport, storage, and supply of electrical energy. Specifically, they can be utilized as power sources of mobile devices such as cell phones, notebook computers, tablets, portable gaming devices. Also, they can be utilized as power sources of movement/transport media such as electric automobiles, hybrid cars, electric motorcycles, and electrically assisted bicycles. Moreover, they can be utilized for backup power sources such as household electricity storage systems and UPSs; power storage facilities that store electric power produced by solar power production, wind power production, and the like; etc.

### REFERENCE SIGNS LIST

1 Positive electrode active material layer
1A Positive electrode current collector
1B Positive electrode tab
2 Negative electrode active material layer
2A Negative electrode current collector
2B Negative electrode tab
3 Separator
4 Outer package

1. A positive electrode active material for a lithium ion secondary battery, comprising:
a compound having a layered rock salt structure and represented by formula (1) below:
LiₓFeₛM¹_{(z-s)}M²_{y}O_{δ} (1)
wherein 1.05≦x≦1.90, 0.05≦s≦0.50, 0.05≦z≦0.50, 0.33≦y≦0.90, 1.20≦δ≦3.10 and z−s≧0; M¹ is at least one element selected from the group consisting of Co and Ni; and M² is at least one element selected from the group consisting of Mn, Ti and Zr; and
a 1,3-propanedione derivative represented by formula (2) below: 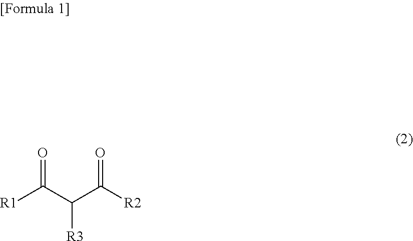
wherein R1 and R2 are each independently a substituted or unsubstituted alkyl group having 1 to 6 carbon atoms, a substituted or unsubstituted aryl group, or a substituted or unsubstituted heteroaryl group; and R3 is a hydrogen atom or a substituted or unsubstituted aryl group.

2. The positive electrode active material for a lithium ion secondary battery according to claim 1, wherein at least a part of a surface of a particle comprising the compound represented by formula (1) is coated with the 1,3-propanedione derivative represented by formula (2).

3. The positive electrode active material for a lithium ion secondary battery according to claim 1, wherein at least one of R1 and R2 in formula (2) is a 2-thienyl group, a 2-furanyl group or a fluorophenyl group.

4. The positive electrode active material for a lithium ion secondary battery according to claim 1, wherein M¹ comprises Ni, and M² comprises Mn in formula (1).

5. The positive electrode active material for a lithium ion secondary battery according to claim 1, wherein the compound represented by formula (1) is a compound represented by Li_{1.4}Fe_{0.2}Ni_{0.2}Mn_{0.6}O_{2.4}.

6. A lithium ion secondary battery comprising a positive electrode comprising the positive electrode active material for a lithium ion secondary battery according to claim 1.

7. The lithium ion secondary battery according to claim 6, comprising a negative electrode comprising a material capable of intercalating and deintercalating lithium ions, and an electrolytic solution.

8. The lithium ion secondary battery according to claim 7, wherein the negative electrode comprises at least one selected from the group consisting of silicon, silicon oxide and carbon.

9. The lithium ion secondary battery according to claim 7, wherein the electrolytic solution comprises at least one of a chain carbonate solvent and a cyclic carbonate solvent.

10. A method for manufacturing a positive electrode active material for a lithium ion secondary battery, the method comprising immersing a particle comprising a compound having a layered rock salt structure and represented by formula (1) below:
LiₓFeₛM¹_{(z-s)}M²_{y}O_{δ} (1)
wherein 1.05≦x≦1.90, 0.05≦s≦0.50, 0.05≦z≦0.50, 0.33≦y≦0.90, 1.20≦δ≦3.10 and z−s≧0; M¹ is at least one element selected from the group consisting of Co and Ni; and M² is at least one element selected from the group consisting of Mn, Ti and Zr, in a solution in which a 1,3-propanedione derivative represented by formula (2) below is dissolved, to coat at least a part of a surface of the particle comprising the compound represented by formula (1) with the 1,3-propanedione derivative represented by formula (2): 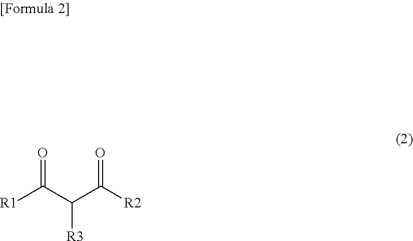
wherein R1 and R2 are each independently a substituted or unsubstituted alkyl group having 1 to 6 carbon atoms, a substituted or unsubstituted aryl group, or a substituted or unsubstituted heteroaryl group; and R3 is a hydrogen atom or a substituted or unsubstituted aryl group.
